(19) United States
(12) Patent Application Publication
(10) Pub. No.: US 2026/0309881 A1
(43) Pub. Date: Oct. 8, 2026

(54) MICROCHANNEL PLATES WITH STRUCTURED CHANNELS CONSTRUCTED FROM PATTERNED LAMINAE

(71) Applicants: The University of Chicago, Chicago, IL (US); Southwest Research Institute, San Antonio, TX (US)

(72) Inventors: Henry J. Frisch, Chicago, IL (US); Kepler Domurat-Sousa, East Lansing, MI (US); Cameron Poe, Dallas, TX (US); Camden Ertley, Boerne, TX (US); Neal Sullivan, Lunenburg, MA (US)

(21) Appl. No.: 19/481,453

(22) PCT Filed: Jun. 5, 2024
(86) PCT No.: PCT/US2024/032595

§ 371 Date: Nov. 4, 2025

Related U.S. Application Data
(60) Provisional application No. 63/471,320, filed on Jun. 6, 2023.
(60) Provisional application No. 63/471,364, filed on Jun. 6, 2023.
(60) Provisional application No. 63/600,884, filed on Nov. 20, 2023.

(51) Int. Cl. G01T 3/00; G01T 1/28

(52) U.S. Cl. CPC G01T 3/006; G01T 1/28

(57) ABSTRACT

Planar and non-planar microchannel plates (MCPs) made from patterned, channel-forming laminae are provided. Also provided are methods of fabricating the MCPs by assembling patterned, dielectric laminae into slabs and methods of using the MCPs to detect photons, including gamma rays, neutrons, charged particles, such as electrons and ions, alpha particles, tritons, and fission products. In the methods of fabricating the MCPs, a slab is assembled via the side-by-side stacking of laminae into a slab. Prior to being incorporated into the slab, the surfaces of the laminae are patterned such that they define structured channels for electron multiplication extending through the thickness of the slab. The channels can run parallel or non-parallel, can have uniform or non-uniform shapes and dimensions, and can have interior surfaces with uniform or non-uniform chemical compositions or surface textures.

### CROSS-REFERENCE TO RELATED APPLICATIONS

The present application claims priority to U.S. provisional patent application No. 63/471,320 that was filed on Jun. 6, 2023, U.S. provisional patent application No. 63/471,364 that was filed on Jun. 6, 2023, and U.S. provisional patent application No. 63/600,884 that was filed on Nov. 20, 2023, the entire contents of each of which are incorporated herein by reference.

### BACKGROUND

Conventional microchannel plates (MCPs) for microchannel plate detectors (MCPDs) are made by assembling bundles (“preforms”) of thin glass fibers which are then elongated through a furnace in a fiber draw tower to shrink the bundle size. The fibers may comprise a solid core of softer glass or may be hollow. The bundles are cut to a length appropriate for assembly into a fixture with transverse dimensions larger than the desired finished size of the channel plate. The bundles are then fused into a solid block under pressure in an oven at high temperature. After fusing and cooling, the block is sliced into blanks for the channel plates, typically with a bias angle. A many-step process of cleaning and functionalization for resistivity and secondary-emission follows. (Wiza, Joseph Ladislas. “Microchannel plate detectors.” Nucl. Instrum. Methods 162.1-3 (1979): 587-601; and Popecki, M. A., et al. “Microchannel plate fabrication using glass capillary arrays with atomic layer deposition films for resistance and gain.” Journal of Geophysical Research: Space Physics 121.8(2016 ): 7449-7460; and D. R. Beaulieu, N. Sullivan, et al., “Novel fast neutron counting technology for efficient detection of special nuclear materials,” 2009 IEEE Conference on Technologies for Homeland Security, Waltham, MA, USA, 2009, pp. 295-301.)

### SUMMARY

Microchannel plates (MCPs) made from patterned laminae that form structured channels in the MCPs and methods of fabricating the MCPs by assembling patterned, dielectric laminae into slabs are provided.

One embodiment of a microchannel plate includes: a slab having a top surface and a bottom surface, the slab comprising a plurality of laminae arranged in a stack and one or more top electrodes on the top surface of the slab and one or more bottom electrodes on the bottom surface of the slab, wherein the top and bottom electrodes are configured to apply a voltage across the slab. The laminae have patterned, channel-defining surfaces that form a plurality of channels extending through the slab from the top surface to the bottom surface. The microchannel plate may, optionally, further include a coating of a secondary emitting material on interior surfaces of the channels and/or a coating of a resistive material on the interior surfaces of the channels.

One embodiment of a method of forming a microchannel plate includes the steps of: patterning surfaces of laminae to form patterned, channel-defining surfaces; applying a coating of a secondary emitting material on the channel-defining surfaces; stacking the laminae side-by-side to form a slab having a top surface, a bottom surface, and a plurality of channels extending through the slab from the top surface to the bottom surface; and forming one or more top electrodes on the top surface of the slab and one or more bottom electrodes on the bottom surface of the slab, wherein the top and bottom electrodes are configured to apply a voltage across the slab.

### BRIEF DESCRIPTION OF THE DRAWINGS

Illustrative embodiments of the invention will hereafter be described with reference to the accompanying drawings, wherein like numerals denote like elements.

FIG. 1: An illustrative rectangular slab comprising channels with several patterned internal structures on its channel-defining surfaces. Structures shown here could further include changes in longitudinal direction, transverse shape and width, modified channel entrance (e.g. funnel) and exit (choke). Additional features may comprise modifications to the surface roughness or texture, non-uniform resistive or secondary-emissive (SEY) coatings, and selective metallization to form dynodes and customized end-spoiling.

FIG. 2: A simplified rectangular ‘slab’ having structured channels that is made of patterned laminae, such as that in FIG. 1. This slab can be designed for gamma ray detection by constructing the laminae from a heavy-metal dielectric such as lead-glass (Pb-glass). The bulk laminae, which represent the largest volume fraction of the slab, serve to convert incoming gamma rays to electrons within the slab.

FIG. 3: An example of a rectilinear pattern of channels having a simple zigzag cross-sectional shape in the plane of the lamina. The zigzag pattern of the channels can be used to tailor the number of electron strikes within the channels and the voltage between strikes of the electron shower.

FIG. 4: A rectangular slab composed of a plurality of stacked and bonded laminae showing an example pattern based on cylindrical channels with a square entrance funnel, discrete metalized dynodes, and exit end-spoiling.

FIG. 5: The predicted electron yield per 511 keV gamma ray traversing a thin sheet of tungsten (W) (solid) and lead glass (Pb-glass) (dashed) versus plate thickness in microns. The yield is for the exit side of the plate. The lower density of the glass is compensated for by the larger depth from which electrons reach the surface. Nominal values are taken for the thickness at which the curve has reached its plateau as 150 microns for Pb-glass and 50 microns for W.

FIG. 6: The predicted electron angular distribution from the exit side of a thin plate from an incident 511 keV gamma ray. The plate thickness for Pb-glass (λ_{R}=0.561 cm) is 150 microns (0.006″) and for W (λ_{R}=0.350 cm) is 50 microns (0.002″).

FIG. 7: The predicted electron energy spectrum from the exit side of a thin plate from an incident 511 keV gamma ray. The plate thickness for Pb-glass (λ_{R}=0.561 cm) is 150 microns (0.006″) and for W (λ_{R}=0.350 cm) is 50 microns (0.002″).

FIG. 8: The electron yield in percent vs path length in a 150-micron-thick (0.006″) Pb-glass lamina for a gamma ray propagating inside the lamina. The yield includes electron emission from both sides of the lamina. Installed in a slab, the lamina could be coated with a secondary emitter such as MgO, Al₂O₃, or Chemical Vapor Deposited (CVD) diamond that the primary electrons from the direct conversion of a gamma ray would traverse at the channel-defining surfaces of the laminae.

FIG. 9: An example of a simple rectangular MCPD comprising two slabs formed with laminae that form zigzag-shaped electron-multiplier channels with entrance funnels. Each channel is of thickness T and transverse dimensions α by γ. The open-area ratio (OAR) is by design small to maximize the area presented to gamma rays for conversion. The laminae are formed with perimeter tabs and to provide mechanical support in columns between the top window and the bottom of the hermetic package.

### DETAILED DESCRIPTION

MCPs made from patterned laminae that form structured channels in the MCPs are provided. Also provided are methods of fabricating the MCPs by assembling patterned, dielectric laminae into slabs with channels containing functional structures.

The MCPs can be designed to detect and identify individual particle types. These particle types include photons, including gamma rays, neutrons, and charged particles, such as electrons and ions, and further include alpha particles, tritons, and fission products, such as heavy nuclei. For example, through the appropriate selection of lamina substrate material, geometry, and/or channel structures, MCPs can be designed for the direct conversion of gamma rays and neutrons to electrons.

In the methods of fabricating the MCPs, a channel plate is assembled by side-by-side stacking and bonding a plurality of laminae into a slab. Prior to being incorporated into the slab, the surfaces of the laminae are patterned such that they define structured channels extending through the thickness of the slab from a first surface of the slab (the ‘top’) to an opposing surface of the slab (the ‘bottom’) when the slab in assembled.

Advantages of the lamina-based approach to MCP fabrication include, but are not limited to: ease and low cost of construction; the ability to fabricate MCPs in a wide range of shapes; flexibility in the selection of substrate materials; flexibility in the design of channel shapes; and flexibility in the choice of channel wall surface modifications and coating materials. These fabrication advantages allow for application-specific optimization of the MCPs in the multi-dimensional parameter space of sensitivity to particle type, efficiency, time and space resolution, gain, rate capability, and cost.

Applications for the MCPs include applications that currently employ MCP-based detectors made by conventional methods, such as visual imaging, particle detection, medical imaging, such as Positron Emission Tomography (PET), and national security. For example, the MCPs can be used to form the amplification stage of MCP-PMT-based photomultipliers, such as a Large Area Picosecond Photo-Detector (LAPPD™), of a type described in Adams, Bernhard W., et al. “A brief technical history of the large-area picosecond photodetector (LAPPD) collaboration.” arXiv preprint ar Xiv: 1603.01843 (2016).

### Laminae and Slabs

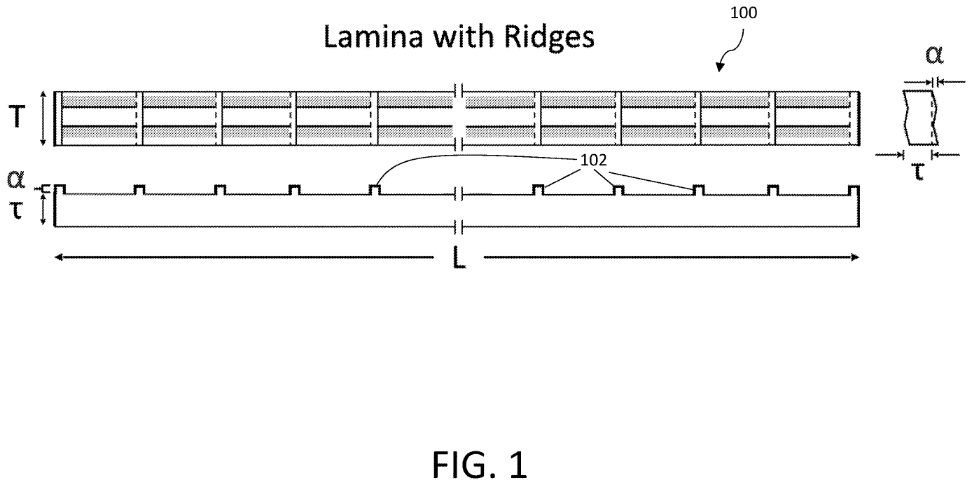

FIG. 1 shows a side view (upper panel) and a top view (lower panel) of one embodiment of a single rectangular lamina 100 characterized by a lamina length, L, a lamina width T, and a lamina thickness, t. For illustration, typical dimensions such as those that would be found in an LAPPDTM are L=20 cm, T ranging from 1.2 mm (for charged particles or photons) to 25.4 mm (for gamma rays), and ω=250 microns.

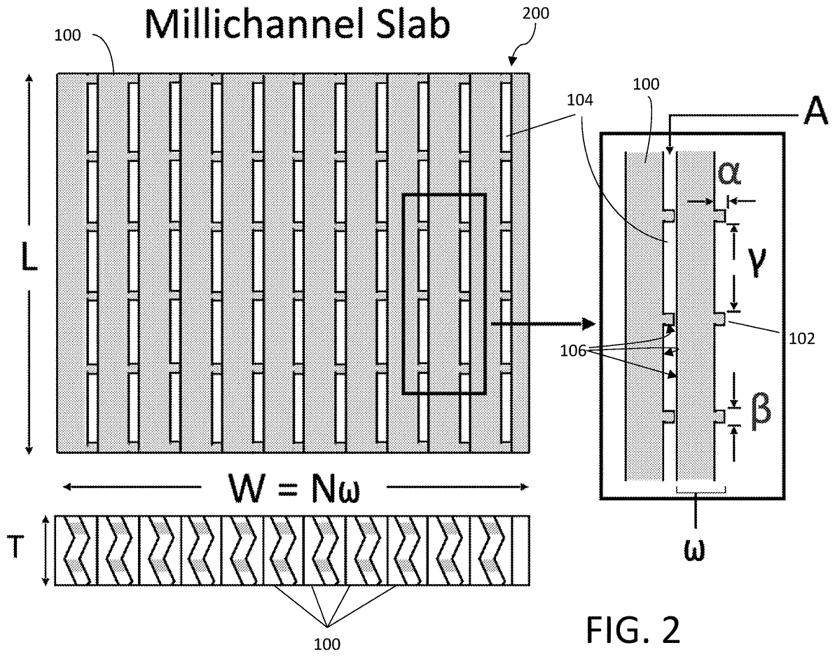

One or more surfaces of the laminae are patterned such that, when the laminae are assembled side-by-side into a slab, the laminae define structured channels extending through the thickness of a slab. For example, lamina 100 of FIG. 1 is patterned with structured ridges 102 of height α, width β, and separation γ, to provide a slab with a plurality of channels 104 extending therethrough (FIG. 2). For the purposes of this disclosure, the surfaces of the laminae that define the channels within the assembled slab are referred to as “channel-defining surfaces.” As shown in FIG. 2, to form a slab, multiple laminae 100 are stacked on edge next to each other in a parallel arrangement to form a rectangular slab 200. For the purposes of this disclosure the channel-defining stack of laminae is referred to as a ‘slab’ to distinguish the stack from a fully-finished MCP, which would further include top and bottom electrodes. In the simple rectangular slab of FIG. 2, the ridges 102 of one lamina abut a surface of an adjacent lamina, to form gaps between the laminae. These gaps will form the electron-multiplying channels of the MCP. In the embodiment of FIG. 2, the channels 104 are characterized by a variable channel dimension α perpendicular to the length dimension, L, of the laminae and channel dimension γ parallel to the length dimension, L, of the laminae.

In the illustrative slab of FIG. 2, surfaces 106 are the channel-defining surfaces. In embodiments in which a channel is defined by neighboring pairs of laminae, the channel-defining surfaces are opposing surfaces of the two laminae. However, in some embodiments of the slabs, a channel may be defined by three or more of the laminae in a slab.

Lamina length, L, corresponds to a length dimension of a slab into which lamina 100 is incorporated; lamina width, T, corresponds to a thickness dimension of a slab into which lamina 100 is incorporated; and a width dimension, W, of a slab formed from the laminae corresponds to the combined laminae thicknesses, Nω, where N is the number of laminae in the stack. However, as discussed in more detail below, because the laminae that make up a slab can have different length, thickness, and/or width dimensions and further because individual lamina within a slab can have different shapes and/or non-uniform lengths, thicknesses, and/or widths, the slab length, slab thickness, and/or slab width may also be non-uniform and the slab non-planar.

The interior channel surface may include one or more micro-electronics sensors that respond to the local electron current to provide measurements of position along the channel and enhanced time resolution of the electron shower. The sensors may comprise or consist of capacitive, inductive, RF-wave guide, and/or charge-sensitive structures. The sensors may comprise active micro-electronic circuitry and passive elements. Signals from the sensors may be analog or N-bit digital, typically with N=1. Signals from the channels are transported to a surface of the slab via imbedded traces on the laminae surfaces, transmission lines, or optically.

It should be noted that although the laminae shown in FIG. 2 are rectangular laminae arranged in a vertical orientation in which the plane of each lamina is parallel with the normal to the slab, the laminae in a stack can also be arranged at a slant, wherein the planes of the laminae form an angle greater than or less than 0° with respect to the normal of the slab. By way of illustration only, the laminae may be slanted at angles in the range from 1° to 89° or in the range from 10° to 80°. A slanted orientation may be advantageous, for example, in MCPs for gamma ray or neutron detection because it allows incident gamma rays and neutrons imagining at normal incidence to the slab to cross more channels within the slab than they would if the laminae had a vertical orientation.

### Patterned Laminae and Structured Channels

Prior to assembling a lamina into a slab, one or more surfaces in the L-T plane of the lamina are patterned to form patterned, channel-defining surfaces, where a patterned surface is a surface that is non-planar and/or a surface that has non-uniform dimensions, non-uniform surface chemistry, and/or non-uniform surface texture. After patterning, the laminae are bonded together into a solid slab comprising a plurality of structured channels. The term “bonded” is used broadly herein to mean secured together and does not indicate that a bonding agent, such as a glue, must be present. For example, neighboring laminae can be “bonded” together by, for example, soldering, gluing, or clamping together-using, for example a frame or clamp. Precision locating holes or external reference grooves can be used to enforce precision alignment and bonding of neighboring laminae. Because the slab shape will be determined by the shapes of the individual laminae, the shape need not be rectangular, of uniform thickness, or lie in a plane.

An advantage of the lamina-based method for slab assembly is that it allows for the patterning of the channel-defining surfaces of the laminae while the channel-defining surfaces are exposed and accessible, before the assembly of the slab. In comparison, the interior surfaces of MCP channels made by conventional methods are only exposed and accessible through their end openings. The increased access to the channel-defining surfaces in lamina-based slab assembly also enables more rapid, large-batch processing.

A non-planar surface may be formed on a lamina by patterning one or more structural features into the surface to provide a non-planar surface topology. Such structures can include, for example, changes in the slope of the surface along the longitudinal and/or transverse directions that form zigzags, arcs, sinusoidal waves, or ribs on the surface. A surface having non-uniform surface chemistry can be formed by applying a non-uniform surface coating, such as a coating of a resistive material, a secondary-emitting material, a low work-function material, or a metal on the surface. The non-uniform coating may be a discontinuous coating, a coating having a non-uniform thickness along the longitudinal and/or transverse directions, or both, and/or a coating having a non-uniform chemical composition.

Coatings of secondary emissive (SEY) materials along the channels can be used to achieve high-gain low-noise electron amplification. A SEY coating material is a material that amplifies a primary electron striking the material within a channel by generating (low-momentum) secondary electrons. Examples of SEY coating materials include MgO, Al₂O₃, and CVD diamond. More information about secondary electron emission materials can be found, for example, in S. X. Tao et al., MDPI Materials, 2016, 9 (1017) and Z. Insepov, et al., Nucl. Instr. Meth A639, 155 (2011).

A resistive material is a material that can be used to provide an accelerating potential along the channel and to supply current to replenish a surface charge within a channel after electron amplification.

Coatings of low work-function materials can be used to enhance the initiatiation of the electron shower by a primary electron generated by a gamma ray emerging from the substrate into a channel.

Depending upon their nature and purpose, the coatings may be continuous or non-continuous along the channel-defining surfaces of a lamina and within the channels of the slab. The lamina-based assembly method allows different coating materials to be applied to the channel-defining surfaces of the laminae, such that a channel formed from the laminae has two or more different materials (e.g., two or more different resistive materials, two or more different metals, and/or two or more different SEY materials) along its length. For example, different SEY coating materials can be deposited along the length of a channel to optimize the gain and/or timing performance of an MCP. Channels having a non-uniform surface roughness along their lengths can also be fabricated.

The patterning of the channel-defining surfaces may be carried out using a variety of known methods, including, for example, etching, lithography, micro-machining, stamping, molding, forming, extrusion, additive/subtractive machining, three-dimensional (3D) printing, imprint printing, focused ion beam patterning, laser patterning, casting, hot embossing, micro-injection molding, or using a core/clad flat boule.

Depending upon the coating material being applied, coatings may be made using a variety of known deposition methods, including Atomic Layer Deposition (ALD), evaporation, vapor deposition (e.g., Chemical Vapor Deposition, CVD), sputtering, and other methods.

The channels made from the patterned laminae can have complex shapes both transverse and longitudinal due to varying surface topography, dimensions (e.g., diameters), shapes, surface compositions (e.g., coatings), and/or textures (e.g., surface roughnesss) along the length of a channel and/or in azimuth around the channel axis. These structures are used to influence the secondary electron shower development in the MCP channels. For example, coatings applied to select, discrete locations in the channels can provide position-dependent gain, rate-capability, or other desired performance as needed in a particle detector in a high-rate environment.

In some embodiments of the MCPs, discrete areas along the interiors of the channels are coated with a metal to provide variable gain, to form discrete dynodes to control electron shower development within the channel, and/or to provide end-spoiling at the bottom openings of the channels. The discrete dynodes can be used to determine the voltage distribution along the channel, forming discrete differential voltage jumps between dynodes. Dynode placement and size can improve rate capability by selectively providing capacitance and current towards the exit of the channels where the electron shower is largest. End spoiling refers to the depth of penetration of the bottom electrodes into the bottom openings of the channels. The extent of this penetration can be tailored to shape the field lines at the exit of the channel. The stacked lamina approach to fabricating the slabs is particularly well-suited to customized tailoring of the end spoiling in the channels because the electrodes can be deposited onto the laminae prior to the assembly of the slabs. For example, customized end-spoiling can be optimized for secondary electron beam collimation, angular emittance, or time resolution.

In some embodiments, the structured channels have modified top openings, such as square or round funnels, to provide a desired open area ratio (OAR), which may be large or small depending upon the type of particle being detected, and/or modified bottom openings to provide exit chokes for shaping and/or directing an emitted secondary electron shower. The top openings of the channels determine the OAR of the MCPs, where the OAR is the ratio of open channel area in the top surface of the slab to the entire effective surface area of top surface of the slab. The laminated slabs can be designed with large OARs, which is advantageous for applications where photoelectrons are generated in a photocathode at the entrance of the channels. Alternatively, the slabs may be fabricated with small OARs, which is advantageous for applications such as gamma ray or neutron detection where a small OAR maximizes the area presented to gamma rays or neutrons for conversion.

Once the laminae have been bonded together into a slab, the top and bottom surfaces of the slab can be metalized to form the electrodes of an MCP. The top and bottom electrodes supply the MCP with voltage, from a voltage source, across the channels to create an accelerating field and supply current for electron amplification (multiplication) along the surfaces of the channels.

The MCPs can be incorporated into MCP-based detectors (MCPDs), which will additionally include various mechanical, vacuum, and electronic components that are commonly found in conventional MCPDs, including high-resolution anodes or other readout devices such as one or more electron detectors, and a hermetic housing appropriate for the particles to be detected. The one or more anodes may be, for example RF strip line anodes or anode pad arrays. A single MCPD may include two or more MCPs in a stack, whereby the secondary electrons exiting the channels of a first MCP are directed towards the channels of the next MCP in the stack.

### Channel Shapes and Dimensions

Conventional MCP channels (‘pores’) typically are round with diameters of less than 100 μm, including channel diameters in the range from 5 μm to 25 μm. The characteristic transverse dimensions of the structured channels described herein will similarly typically be are less than 100 μm, including features in the range from about 1 μm to about 25 μm, but can extend into the mm scale. The channel lengths in an MCP are typically characterized by a Length over Diameter (LOD) parameter, which is the ratio of channel plate thickness to channel diameter. Typical values of LOD are 40-100. These small channel dimensions enable the fabrication of large area slabs with a high channel count. For example, slabs having top and bottom surface areas of 500 cm² or greater with millions of channels can be fabricated. The dimensions recited here are for illustrative purposes only.

The channels having a uniform rectangular cross-section in FIG. 2 are shown for illustrative purposes only. The laminae can also be patterned to provide channels with other cross-sectional shapes, including cylindrical, elliptical, triangular, or hexagonal cross-sectional shapes. Moreover, the diameter and/or shape of the channels need not be uniform through the thickness of the slab and, therefore, the channels can be formed with internal structures, such as strike surfaces, entrance funnels at the top opening of the channels, and/or exit structures, such as chokes that change (e.g., narrow or enlarge) the diameter and/or cross-sectional shape of the channel at its end opening.

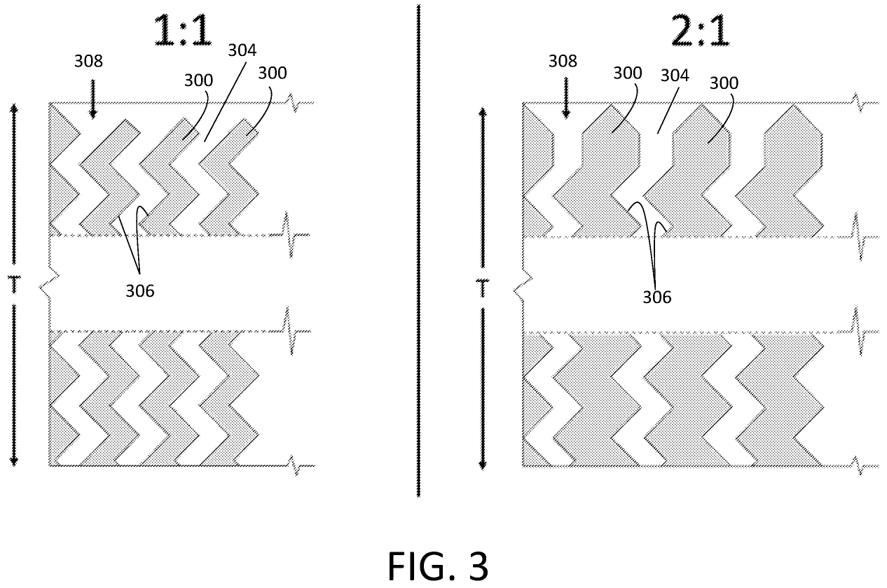

FIG. 3 shows two examples of slabs having channels with non-uniform cross-sections. In these slabs, the channel-defining surfaces 306 of neighboring laminae 300 define channels 304 with an entrance funnel 308 and a zigzag (or “chevron”) pattern along the length of the channel. In the chevron pattern, the bias angle (i.e., the angle defined by an axis running through the thickness dimension, T, of the slab and the channel-defining surface) changes along the length of the channel in a repeating pattern to form a series of particle strike surfaces along the channel that enhance interactions between gamma rays, neutrons, or electrons with the channel walls at certain intervals. This channel design is advantageous because modulating the distance between collisions within a channel can sculpt the distribution of collision energies, narrowing the electron distributions in timing and current at the channel exit. The ratio of solid lamina substrate volume to open channel volume in the slabs in the left and right panels in FIG. 3 are 1:1 and 2:1, respectively. Higher ratios of solid lamina substrate volume to open channel volume may to preferred for applications in which primary electrons are generated within the slabs, as is the case in gamma ray and neutron detectors.

The channels disposed in a parallel arrangement through the thickness of the slab in FIG. 2 and FIG. 3 are shown for illustrative purposes only. It is possible to design the channel-defining surfaces of the laminae to provide channels that run in a non-parallel arrangement along their lengths through the slab. Non-parallel channels can be formed, for example, using two, three, or more laminae to define angled channels Slabs with non-parallel channels may themselves be planar or non-planar and can be useful, for example, as quasi-optical elements, as discussed in more detail below.

### Slab Shapes and Dimensions

As shown in FIG. 2, the individual lamina that form a slab determine the exterior shape and dimensions of the slab, as well as the locations and cross-sectional shapes and dimensions of the channels. The exterior shape of a given lamina in a slab defines the cross-sectional shape of the slab at the location of that lamina. The slabs may be planar or non-planar.

For a planar MCP, the laminae that make up the slab may be rectangular and identical, as shown in FIG. 2. For a non-planar slab, at least some of the laminae can have curvilinear exterior surfaces. Moreover, the dimensions of the laminae within a slab need not be the same throughout the stack. For example, one or more of the laminae may be wedge shaped along their length dimension, L.

The laminae within a slab also can be stacked in an offset arrangement along the width, W, dimension of the slab to form non-planar exterior surfaces along the width dimension. This flexibility in the design and arrangement of the laminae making up a slab enables the shape and dimensions of the slab to be highly tailorable.

In some embodiments of the slabs, the laminae are shaped and arranged in a stack to provide non-parallel channels and/or channels with diameters that vary through the thickness, T, of the slab. Such a slab design is advantageous for the fabrication of slabs that act as quasi-optical elements to direct the shower of electrons exiting the channels along external field lines. Depending on the intended application for the MCP, the electrons exiting the channels can be focused onto one or more electron sensors, focused to form an electron beam, defocused, or spatially directed to achieve selective imaging. The slabs, including slabs with non-parallel channels, may have non-planar shapes in order to facilitate electron beam formation, electron focusing, or electron defocusing. By way of illustration only, the slabs may have a spherical sector shape, such as a hemisphere, a spherical cap shape, or a saddle shape to facilitate electron beam formation, electron focusing, or electron defocusing along external field lines.

In some embodiments of the slabs, one or more exterior surfaces of one or more laminae making up a slab can include integrated structural features. In some embodiments of the slabs, the integrated structural features are tabs (i.e., protrusions) integrated on the perimeter of a lamina that lie in the plane of the lamina. Other structural features that may be integrated into the perimeter of the laminae include pins, sockets and/or hooks. These integral structural features can be used to provide mechanical support, spacing, and/or alignment of the MCPs when the MCPs are assembled with other components into an MCPD or when assemblies of two or more MCPs are assembled into a detector package. By way of illustration, the exterior surfaces of one or more laminae can define protruding tabs that act as spacers precisely defining the spacing between one MCP and another, or between an MCP and a window, housing side-wall, or top plate of a hermetic package of an MCPD. Tabs on neighboring MCPs can form a column between an upper MCP and a lower MCP to support atmospheric pressure, for example. The structural features may also mate with corresponding structural features on neighboring MCPs or other MCPD components, such as a window, housing, or top plate of a hermetic package for mechanical mounting and/or alignment.

### Non-Uniform Slab Material Compositions

In some embodiments of the MCPs, the substrate material of the lamina may be chosen to have varying efficiencies for direct conversion of gammas, neutrons, alpha particles, and charged particles, including electrons. A given slab may contain laminae of different materials to provide differential sensitivity to the components of an incident particle flux. The laminae may be interspersed to provide multi-particle sensitivity. Alternatively, the laminae may be clustered into areas large enough to provide regions on a high-resolution anode of an MCPD such as the LAPPD™ appropriate for one particle type, for example for gamma rays or for neutrons.

In some embodiments of the MCPs, special laminae made of a non-conducting material chosen for strength, such as alumina, can be interspersed with the other laminae (e.g., the channel-defining laminae) in the slab at intervals. These ‘strong-backs’ can be structural elements in the internal mechanical assembly to support the columns, for example.

### Detector Types

The MCPs can be integrated into a variety of MCPDs, including photon and charged particle detectors, gamma ray detectors, and neutron detectors. In the detectors described below, gamma rays, which are high energy photons, are distinguished from lower energy photons.

The dielectric material from which the laminae are composed may be selected based upon the particle type or types to be detected, for example glass loaded with heavy metals for gamma rays and either hydrogenous materials such as plastic or glass loaded with light isotopes such as ¹⁰B, ⁷Li, or fissionable material for neutrons. (For the purposes of this disclosure, a heavy metal is a metal element having an atomic number of 74 or greater.) Generally, however, the lamina substrate material should be able withstand a vacuum bake-out, should be able to sustain a voltage drop on the order of a kilovolt per mm through its thickness, and should be capable of having structural features patterned into its surface. It may be beneficial to use substrates composed of resistive materials in order to obviate the deposition of resistive coatings on the channel-defining surfaces of the laminae.

New MCP capabilities from a lamina-based fabrication approach include direct conversion of gamma rays and neutrons in the substrate with subsequent amplification in the channels, non-uniform gain and rate capabilities over the MCP surface, amplifying, focusing and transporting beams of charged particles, multi-modality detectors via simultaneous sensitivity to different particles such as neutrons and gamma rays by incorporation of different lamina substrates with varying efficiencies into discrete areas in the MCP, varying channel size, shape, direction, or functionality over the MCP surface, varying OAR due to varying entrance pore shapes, varying exit pore shapes, non-uniform MCP thickness, greater non-planarity than can be achieved by the conventional glass slumping method, and the inclusion of locating and spacing tabs, pins, and other mechanical features to facilitate assembly in a stack of MCPs and other elements such as anodes and converters.

### Gamma Ray Detectors

For gamma ray detection, the bulk laminae substrate can be composed of a material that directly converts an incoming gamma ray into an electron (a ‘primary’ electron) within the laminae substrate. In gamma ray detectors, such electrons may be generated by the Photoelectric Effect, Compton Scattering, or Pair Production, depending on the gamma ray energy at 511 keV, the gamma ray energy from positron-electron scattering. The primary purpose of the gamma ray conversion material is to provide enough nuclear cross section to an incident gamma ray to generate a primary electron. When the primary electron traverses a SEY coating material on the slab (e.g., coated on an interior surface of a channel), secondary electrons are produced. Therefore, in some embodiments of the gamma ray detectors, the laminae are made with a material loaded (or “doped”) with heavy metal nuclei and the optimal thickness of the laminae and slabs is determined by the escape depth of the electrons produced by the interaction of the gamma ray with the lamina substrate material.

The gamma ray conversion material may be a material containing or consisting of high atomic number (Z) atoms, although low Z atoms are also suitable, provided they are capable of direct conversion of an incident gamma ray. Suitable gamma ray conversion materials may comprise metal nuclei, such as iron (Fe), copper (Cu), zirconium (Zr), barium (Ba), bismuth (Bi), tungsten (W) or lead (Pb). For example, dielectric materials loaded (or “doped”) with metal nuclei may be used. These include metal-loaded glasses (“metallic glasses”), such as lead-glass (Pb-Glass) or tungsten-glass (W-Glass), metal oxides, metal ceramics, and metal-loaded plastics such as polyether ether ketone (PEEK).

The ability of media comprising or consisting of heavy metal atoms to directly convert gamma rays into primary electrons in a near-surface region is illustrated in the Example, which reports the results of simulations of the interaction of gamma rays with tungsten and lead-glass substrates.

### Neutron Detectors

For neutron detection, the bulk lamina substrate can be composed of a material that converts incoming neutrons into recoil particles. The neutron detectors may have the same basic geometry as the gamma ray detectors described above, but utilize conversion materials that directly convert an incident neutron into the recoil particles when the neutron interacts with a lamina. These recoil particles then excite secondary electrons when they interact with an SEY material coating on the slab (e.g., on internal surfaces of the channels).

Depending upon factors such as the energy of the neutron, a recoil particle may be, for example, an alpha particle, proton, triton, gamma ray, or fission product. The neutron conversion materials generally comprise an active element contained in a dielectric material, such as a glass (e.g., a borosilicate glass or Pb-glass), ceramic, or plastic. Some active elements for the laminae of the neutron detectors are boron (B), cadmium (Cd), gadolinium (Gd), and lithium (Li). The material density and composition of the neutron conversion material can be selected to optimize neutron conversion, detector timing/space resolution, and mechanical robustness. For example, in some embodiments of the neutron detectors, the neutron conversion material is a hydrogen-rich plastic or glass loaded with light isotopes, such as ¹⁰B or ⁷Li, Cd, Gd, or fissionable heavy nuclei such as U₂₃₅. Glasses loaded with fissionable isotopes of heavy metal nuclei such as uranium can produce secondary products with ranges comparable to the thickness of thin-walled patterns on the laminae channel-defining surfaces.

By way of illustration glass loaded with ¹⁰B can produce an alpha particle and a 480 keV gamma ray. More details regarding some examples of neutron conversion materials can be found in: Anton S. Tremsin. W. Bruce Feller, and R. Gregory Downing. “Efficiency optimization of microchannel plate (MCP) neutron imaging detectors. I. Square channels with 10B doping.” Nuclear Instruments and Methods in Physics Research Section A: Accelerators. Spectrometers. Detectors and Associated Equipment 539.1-2 (2005): 278-311; Beaulieu, D. R., et al. “Novel fast neutron counting technology for efficient detection of special nuclear materials.” 2009 IEEE Conference on Technologies for Homeland Security. IEEE, 2009, and Radiation Detection and Measurement; Glenn F Knoll; Wiley; 4th ed (2010) ISBN 978-0-470-13148-0; and Radiation Detection and Measurement; Glenn F Knoll; Wiley; 4^{th} ed (2010) ISBN 978-0-470-13148-0.

By way of further illustration, fast neutron (~1 MeV) detection can be accomplished through the direct conversion of a fast incident neutrons into a recoil proton via the neutron-proton (n-p) recoil reaction within a hydrogen-rich (e.g., plastic) conversion material. The recoil proton has a short range in dielectric material and will excite secondary electrons as it exits the dielectric material and traverses a secondary electron emission coating. The secondary electrons can then be amplified in the channels.

Alternatively, to detect thermal neutrons (~0.025 eV), the neutron conversion material can incorporate high-efficiency neutron conversion active elements such as ¹⁰B or ¹⁵⁷Gd, providing a high neutron stopping power. For example, by incorporating ¹⁰B into the dielectric, the neutron conversion reaction produces ⁷Li (1.01 MeV) and a recoil alpha particle (1.8 MeV) (6%) or ⁷Li (0.84 MeV) an alpha particle (1.47 MeV) and a gamma ray (0.48 MeV) (94%). The alpha particles produced in either reaction have a short range (3.5 mm) in the dielectric lamina and will excite secondary electrons as they exit the dielectric material and traverse a secondary electron emission material.

For neutron flux measurements in environments with backgrounds, the slab may be made of laminae of the same substrate material, or of laminae including different substrate materials. An example use is for measuring gamma ray backgrounds in high radiation nuclear environments; a slab comprising neighboring areas of neutron-sensitive laminae and gamma-sensitive laminae in an MCPD with high spatial resolution readout would measure the ratio. Multiple such areas with varying neutron and gamma sensitivity would provide additional constraints on the gamma/neutron flux ratio.

### Direct Conversion of Gamma Rays and Neutrons

The ability to fabricate the channel plate of an MCP from a material that is capable of the direct conversion of a gamma ray or neutron is highly advantageous because it enables fast, high-gain, economical detection. In addition, the gamma ray detectors described herein eliminate the two-step process of generating optical photons in a scintillator system and then converting the photons into electrons in a separate photodetector system. Therefore, the gamma ray detectors based on laminated slabs, which do not require a scintillator, can be more compact than conventional gamma ray detectors in which the gamma-to-electron converting material is distinct from, and located outside of, the MCP detector.

In addition to being easier and less expensive to integrate into large systems such as PET scanners, a more compact gamma ray detector will have better timing resolution, which is important in time-of-flight measurements such as those used in TOF-PET and particle physics.

It is desirable for the laminae substrate material in a gamma ray or neutron detector to make up a large fraction of the slab volume and a large fraction of the area of the top surface of the slab in order to maximize the area presented to gamma rays or neutrons for conversion, subject to the requirement that the thickness of the walls between channels on the surface of the laminae is less than or comparable to the range of the secondaries produced by the direct conversion.

A consideration for gamma ray detectors that incorporate the laminated slab-based MCPs described herein for direct conversion is that, because the primary electrons generated by gamma rays may cross a channel at different points along the length of said channel, the gain can vary. In a gamma ray MCPD that includes multiple MCPs in a vertical stack, this issue can be addressed by constructing the slab of the final MCP in the stack from a material that does not efficiently convert incoming gamma rays into electrons (e.g., by using a conventional MCP as the last MCP in the stack), and operating the final MCP in saturation mode.

A similar consideration for neutron detectors that incorporate the laminated slab-based MCPs described herein for direct conversion is that, because the secondaries generated by the neutron, which may include protons, alpha particles, tritons, gamma rays, and fission products depending on the material of the substrate, may cross a channel at different points along the length of said channel, the gain can vary. In a neutron MCPD that includes multiple MCPs in a vertical stack, this issue can be addressed by constructing the slab of the final MCP in the stack from a material with a lower neutron cross-section (e.g., by using a conventional MCP as the last MCP in the stack), and operating the final MCP in saturation mode.

### Photon Detectors

As used herein, the term photon detector is a detector for photons, such as UV and optical photons, with energies substantially lower than those of gamma rays. In this case the laminated slab-based MCPs will generally be made of dielectric materials, such as glass, ceramics, or plastics. For photon detection, the entrance openings of the channels, which may include funnels for high OAR, may be coated with a photocathode material that converts incident photons into primary electrons that create a secondary electron shower in the channels of the MCP. However, the photocathodes do not have to be integral to the MCPs; they may be separate and distinct device elements positioned outside of the MCP, but positioned to release secondary electrons into the channels. Suitable photocathode materials include compounds of antimony, potassium, sodium, or cesium. For electron and other charged particle detectors, a photocathode is not needed and the entrance channel can be coated with a high-SEY material.

### Charged Particle Detectors

Stable or long-lived charged particles, such as protons, pions, kaons, muons and electrons, are conventionally detected by a MCPD through photons created by the particle's traversal of a scintillating medium or the creation of Cherenkov photons in a transparent radiator such as quartz followed by a photocathode to convert the photons to electrons. An MCP constructed from laminae operates on the same principles as a conventional MCPD and will detect and multiply these electrons in the channels.

In addition, charged particles may be detected by direct conversion, as the particle traversing the slab will generate secondary electrons in the SEY layers of the channels, generating an electron shower in each channel traversed. In an MCPD with a high-resolution anode readout both localization and possibly directional information will be recorded.

In addition to the detection of the above charged particles, the MCP described here can detect at some efficiency ions, nuclei, and other more complex arrangements of protons, neutrons, and electrons.

### Illustrative Embodiment

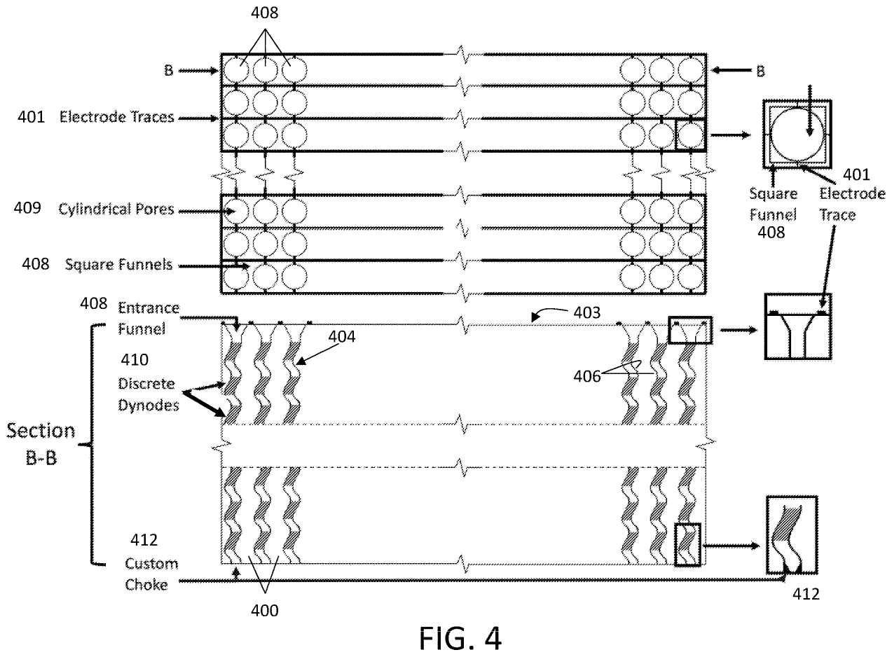

For purposes of illustration, FIG. 4 is a schematic diagram showing a lateral cross-sectional view (i.e., a cross-section through the width, W, of the slab; upper panel) and longitudinal cross-sectional side view (i.e., a cross-section through the thickness, T, of the slab; lower panel) of one embodiment of a laminated slab for an MCP detector with channels that include discrete dynodes, opening funnels, and end chokes that narrow the diameters of the channels at their end opening.

The slab of FIG. 4 is composed of a plurality of laminae 400 with channel-defining surfaces 406 that define a plurality of channels 404 having a wavy (e.g., sinusoidal) cross-section through the thickness of the slab and a circular cross-section through the width of the slab. Square entrance funnels 408 at the top surface of the slab open into the circular channels 404. (A top view of the entrance funnels is shown at the top right in FIG. 4.) Square entrance funnels 408 cover the top surface 403, except where electrode traces 401 are provided. As a result, the slab has a low effective OAR and is well-suited for use in an MCP for gamma ray detection. Electrode traces 401 define one or more top electrodes and one or more bottom electrodes on the slab. The top and bottom electrodes are connected to a voltage source and are configured to apply a voltage across the slab when the MCP is in operation.

Discrete dynodes 410 in channels 404 control the voltage distribution along the channels, and a custom choke 412 (enlarged at lower right) is provided to shape the charge cloud formed by the electrons exiting channel 404.

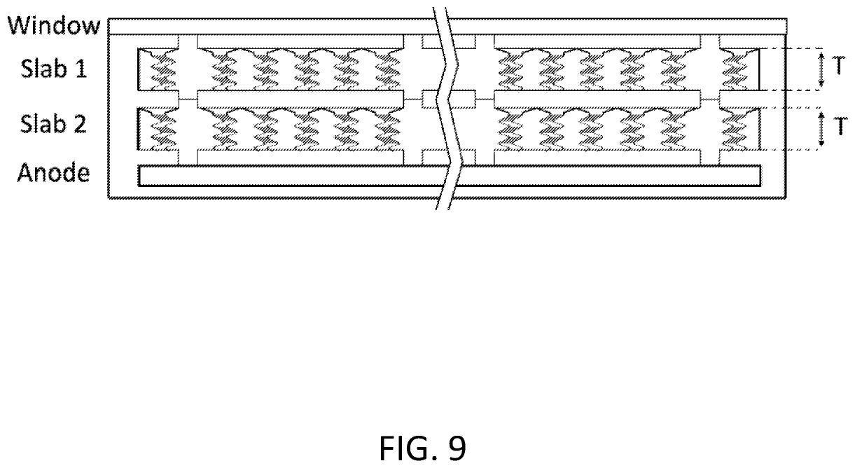

FIG. 9, which is discussed in the Example, shows an example of an MCP having two laminated slabs of the type depicted in FIG. 4.

### An Example: Gamma Ray Detection in Medical Imaging

This example describes the use of a modified TOPAS simulation package to study the efficiencies of lamina-based MCP geometries with extended path lengths for gamma ray conversion. (TOPAS simulation package; B. Faddegon, et al., European Journal of Medical Physics; Volume 72, P114-121, April (2020).)

### Simulation of Gamma Ray Processes at 511 keV Input to an MCP with a Laminated Slab-Based Channel Plate

The MGM can be optimized for the detection of gamma rays. The method utilizes the direction conversion of a gamma ray to an electron or electrons in a solid material, often a metal or a dielectric. The three fundamental conversion processes are the Photoelectric Effect, Compton Scattering, and, at gamma ray energies above 1 MeV, Pair Production. Here we present results from a simulation based on modifications to the TOPAS framework for 511 keV gamma rays, the energy corresponding to positron-electron annihilation, used in Positron-Emission Tomography (PET) and Single Photon Emission Computed Tomography (SPECT).

The efficiency to make an electron that exits the lamina substrate and arrives at the amplification channel is a convolution of the efficiencies for producing an electron and for the electron penetrating the material into the channel The production and escape factors vary with material: solid metal tungsten (W), for example, has a high conversion cross-section, but a short escape depth. A dielectric such as lead glass, for example, has a lower conversion cross-section but a longer escape depth.

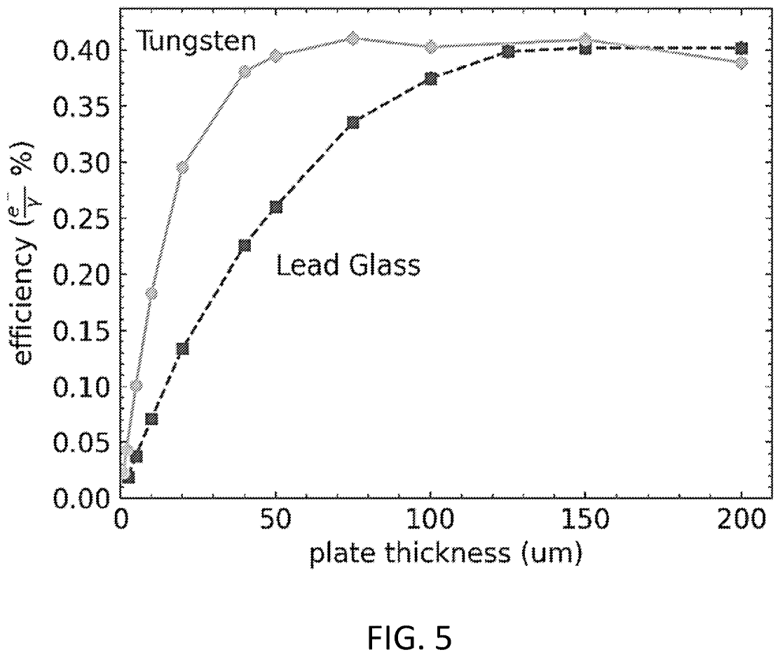

FIG. 5 shows the predicted electron yield per 511 KeV gamma ray traversing a thin sheet of lead glass (dashed) at normal incidence versus plate thickness in microns. The yield is for the exit side of the plate. The lower density of the glass compared to a pure heavy metal such as tungsten (W) is compensated by the larger depth from which electrons reach the surface. We take as nominal values for the thickness at which the curve has reached its plateau as 150 microns for Pb-glass and 50 microns for W.

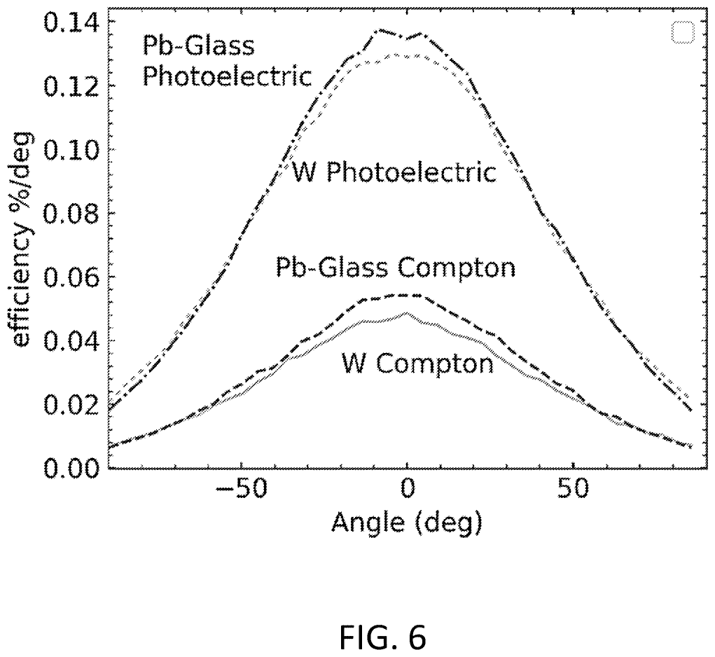

FIG. 6 shows the predicted electron angular distribution from the exit side of a thin plate from an incident 511 keV gamma ray. The plate thickness for Pb-glass is 150 microns (0.006″) and for W is 50 microns (0.002″).

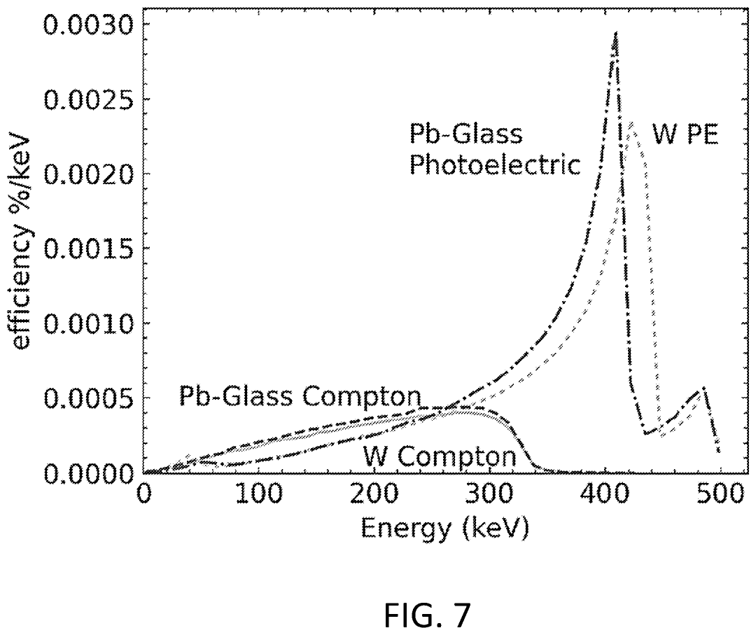

FIG. 7 shows the predicted electron energy spectrum from the exit side of a thin plate from an incident 511 keV gamma ray. The plate thickness for Pb-glass is 150 microns (0.006″) and for W is 50 microns (0.002″).

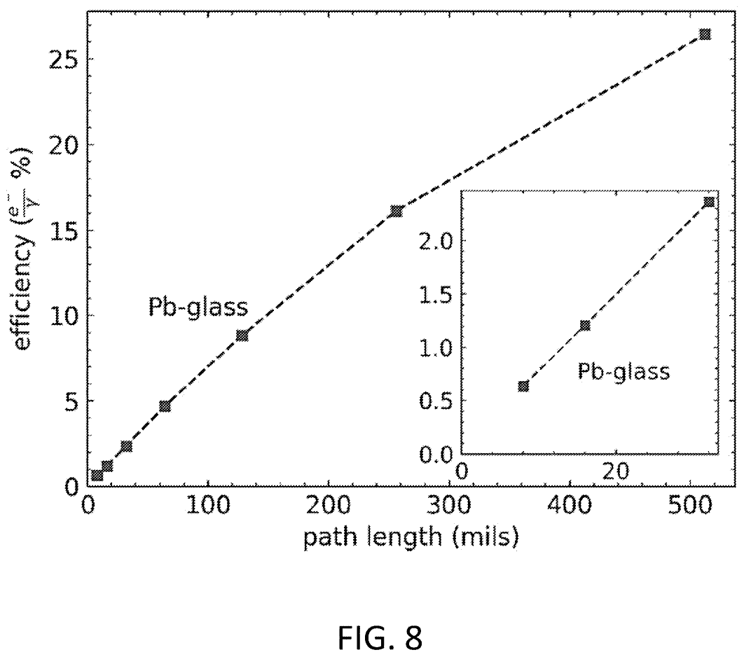

FIG. 8 shows the efficiency for the production of an electron that exits a lamina through either surface versus the path length of a 511 keV gamma ray traveling inside a Pb-glass lamina substrate of thickness 150 microns (0.006″). Note that the efficiency in Pb-glass is 25% at a path length for direct conversion of ½″ and is linear in path length. The same mechanism, but with emitted protons, alpha particles, or tritons would apply to a neutron in a ¹⁰B or Li-loaded glass.

FIG. 9 shows an example detector assembly comprising 2 slabs formed with patterned laminae that form structured multiplying channels. Each channel is of nominal length T, the thickness of the slab, and transverse dimensions a by y, where a is the height of the ‘ridge’ or spacer between laminae. The OAR is by design small to maximize the area presented to gamma rays for conversion. More slabs can be added in series to provide a higher conversion efficiency.

The use of a ‘stack’ of MCPs as indicated in FIG. 9 allows saturating the electron shower detected at the anode. As the primary electron from the gamma ray may cross a channel at any point along its length, the gain in a slab varies. The last slab in a stack can be constructed for low gamma ray cross-section and run in saturation mode to produce a distribution in pulse height with a lower cutoff above electronics threshold. The change in gain and pulse shape longitudinally in a channel can be sculpted by positioning the dynodes towards the exit end of the channel.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.” The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention.

The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

1. A microchannel plate comprising:
a slab having a top surface and a bottom surface, the slab comprising a plurality of laminae arranged in a stack, wherein the laminae have patterned, channel-defining surfaces that form a plurality of channels extending through the slab from the top surface to the bottom surface;
optionally, a coating of a secondary emitting material on interior surfaces of the channels;
optionally, a coating of a resistive material on the interior surfaces of the channels; and
one or more top electrodes on the top surface of the slab and one or more bottom electrodes on the bottom surface of the slab, wherein the top and bottom electrodes are configured to apply a voltage across the slab.

2. The microchannel plate of claim 1, wherein the laminae comprise a dielectric material.

3. The microchannel plate of claim 1, wherein the patterned, channel-defining surfaces comprise at least one surface that is non-planar along a longitudinal direction.

4. The microchannel plate of claim 1, wherein the patterned, channel-defining surfaces have a zigzag pattern and the channels defined by the channel-defining surfaces have a zigzag cross-sectional shape along a longitudinal direction.

5. The microchannel plate of claim 1, wherein the patterned, channel-defining surfaces comprise at least one surface having a non-uniform dimension along a lateral direction.

6. (canceled)

7. The microchannel plate of claim 1, wherein the laminae are comprised of a resistive material.

8. The microchannel plate of claim 1, wherein discrete areas of the patterned, channel-defining surfaces are coated with a coating material.

9. The microchannel plate of claim 8, wherein the coating material comprises a secondary emitting material.

10. (canceled)

11. The microchannel plate of claim 8, wherein the coating material comprises a resistive material.

12. The microchannel plate of claim 8, wherein the coating material is a metal and the discrete metal-coated areas define two or more discrete metal dynodes within one or more of the channels in the plurality of channels.

13. The microchannel plate of claim 1, wherein the patterned, channel-defining surfaces comprise at least one surface having a non-uniform surface texture.

14. The microchannel plate of claim 1, wherein the laminae comprise a material that generates primary electrons upon irradiation with gamma rays.

15. The microchannel plate of claim 14, wherein the material generates the primary electrons upon irradiation with gamma rays via a Compton, Photoelectric, and/or Pair Production effect.

16. The microchannel plate of claim 15, wherein the material is loaded with a heavy metal.

17. (canceled)

18. The microchannel plate of claim 14, wherein the channel-defining surfaces are coated with a secondary emitting material.

19. (canceled)

20. The microchannel plate of claim 1, wherein the laminae comprise a material that generates recoil particles upon irradiation with neutrons.

21. The microchannel plate of claim 1, wherein at least some of the channels in the plurality of channels are non-parallel along their lengths.

22. (canceled)

23. The microchannel plate of claim 1, wherein at least some of the laminae within the plurality of laminae have different exterior shapes, dimensions, or both, such that at least one exterior surface of the slab is non-planar.

24. The microchannel plate of claim 1, wherein the slab has a non-uniform thickness along at least one direction.

25. A method of forming a microchannel plate, the method comprising:
patterning surfaces of laminae to form patterned, channel-defining surfaces;
applying a coating of a secondary emitting material on the channel-defining surfaces;
stacking the laminae side-by-side to form a slab having a top surface, a bottom surface, and a plurality of channels extending through the slab from the top surface to the bottom surface; and
forming one or more top electrodes on the top surface of the slab and one or more bottom electrodes on the bottom surface of the slab, wherein the top and bottom electrodes are configured to apply a voltage across the slab.
